(19) United States
(12) Patent Application Publication
(10) Pub. No.: US 2015/0317454 A1
(43) Pub. Date: Nov. 5, 2015

(54) TAMPER-RESISTANT EMERGENCY MEDICAL RESERVE REPOSITORY

(71) Applicant: Guy Kruger, Willard, UT (US)

(72) Inventor: Guy Kruger, Willard, UT (US)

(21) Appl. No.: 14/268,946

(22) Filed: May 2, 2014

(51) Int. Cl. G06F 19/00

(52) U.S. Cl. CPC G06F 19/3462

(57) ABSTRACT

A method, computer program product and system are disclosed for securing, refrigerating and warehousing controlled substances, such as prescription medications. Beneficially, various embodiments of the present invention include carousels, track shelving, manual and electric combination locks, and other varied internal mechanisms for storing and dispensing medication only to predetermined individuals at predetermined intervals.

### BACKGROUND OF THE INVENTION

1. Field of the Invention

This invention relates to medication storage containers, and more specifically relates to a secured medication storage unit for storing and dispensing controlled substances in emergencies.

2. Description of the Related Art

Individuals who are compelled by heath problems to rely on prescription medications must often make perpetual use of those medications at certain predetermined intervals for throughout their lives. An individual's non-receipt of certain medications, or inability to obtain them, can result in death, distress or permanent disfunction. This includes diabetics needing insulin and organ transplant recipients needing immunosuppressants, as well as heroine addicts needing methadone and psychiatric patients clinically addicted to antidepressants. Because these medications are controlled, and available only in small quantities at a time, any world wide natural or economic disaster which interrupted either the manufacture or supply lines of these medications would have devastating results on those reliant upon them. The possibility of a catastrophic event, and the legal inability of patients to stockpile needed medications, can be an ongoing source of anxiety, distress, fear and depression.

A secured device, which cannot be tampered with and which dispenses stockpiled medication at predetermined intervals, is needed in the art. Beneficially, this device might receive instruction from, or fall under the control of, a managing authority, such as a pharmacy, municipality or the FDA. This vault might be controlled via a computer network, such as a local area network (LAN) or wide area network (WAN). In some embodiments, this device might dispense medication to authorized personnel for subsequent dispersion to patients.

Some medication dispensing devices are known in the art. U.S. Pat. No. 5,912,818 discloses a medication dispensing device without heightened security. U.S. Pat. No. 6,163,736 discloses a tamper resistant programmable medication dispenser with some security features. The disclosed device utilizes an indexing wheel to supply medication at varied intervals for each day of the week the dispenser is in use. U.S. Pat. No. 6,382,416 discloses a medication safety storage system, which restricts access to medicines to authorized persons who have preprogrammed a micro processor to recognize their unique fingerprint. U.S. Pat. No. 6,415,202 discloses a tamper resistant programmable medicine dispenser, which incorporates a programmable timer and a device assembly for selectively indexing a plurality of separate containers relative to a dispenser outlet. U.S. Pat. No. 6,662,081 discloses a medication regime container and system, which includes a holder for multiple storing and dispensing units in an ordered fashion consistent with the daily requirements of a medication regime.

None of these devices provide security, refrigeration, or an interface with a controlling authority. What are needed are a device, system and method which do.

### SUMMARY OF THE INVENTION

From the foregoing discussion, it should be apparent that a need exists for a tamper-proof emergency medication reserve repository. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a secured medication warehousing vault for dispensing prescription medication to patients, the vault comprising: a steel housing securely enclosing operational components of the vault during unattended operation, the housing defining an aperture for dispensing jars of medication; a graphical user interface (GUI or “display”) for interfacing with a patient disposed on a forward side of the housing; an internal carrousel comprising a plurality of slots disposed axially on a baseplate around a driveshaft, the slots for storing cylindrical jars of between 0.1 liters and 1 liter in volume; a card reader affixed to, and in supporting relation with, the housing; an internal clock configured to relay a first output signal to an electromechanical dispenser after a predetermined period of time has passed in response to receipt of an input signal originating with the processor; the electromechanical dispenser for dispensing medication from a shelf of the carrousel out of the aperture, the dispenser configured to dispense medication from a slot in response to receiving a second output signal from the processor and a first output signal from the clock; and a processor housed within the housing, the processor in operative connection with persistent computer readable storage, the card reader, the internal carrousel, the dispenser and the GUI, wherein the processor configured to create and output a plurality of output signals.

With respect to the vault, the processor is responsive to data read by the card reader to create a first output signal causing the internal carrousel to rotate a distance of one slot, and wherein the processor is responsive to data read by the card reader to create a second output signal causing the dispenser to dispense medication from a slot in the internal carrousel to the patient.

The apparatus may further comprise a steel door with a locking mechanism for replenishing medication in the internal carrousel. The apparatus may further comprise a communication module configured to communicate logically with a controlling authority over a WAN.

The apparatus may further comprise one or more motor affixed to gears, the gears engaging teeth on the bottom of the baseplate for rotating the carrousel around the driveshaft.

The apparatus, in some embodiments, further comprises a camera for recording patient interaction with the apparatus, the camera connected with a signal bearing medium to internal nonvolatile computer readable memory.

In some embodiments, the apparatus further comprises one or more sliding door(s) of a width equivalent to a width of a slot, the sliding door(s) slidably affixed to the carrousel, the sliding door(s) rotating axially around the carrousel.

The apparatus may also further comprise a plurality of internal carrousels stacked one upon another, each carrousel stocked with medication warehoused within the vault for a specific patient.

In some embodiments, the apparatus further comprises a plurality of vaults stacked side-by-side and one upon another to form a plurality of adjacent walls, the walls forming a walk-in vault, each vault in the walk-in serialized with a printed label, each vault comprising medication for one or more patients.

A system to securely dispense medication to a patient is also recited, the system comprising: a housing defining a hollow recess; a processor; computer readable data storage means for storing computer readable data; a relational database management system (RDBMS); a GUI; a card reader; an accessor module configured to electronically access patient information in persistent memory, said patient information accessible only through a grant of permission of the patient with a PIN number; a transmitter module configured to transmit an event code to a server under the control of a governmental authority; a receiver module configured to receive a series of TCP/IP packets from the server and verify an authorization code contained in the TCP/IP packets; a dispenser module configured to dispense medication from an internal carrousel to the patient in response to a signal from the receiver module sent in response to the verification of the authorization code.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper perspective view of one embodiment of a secured medication reserve vault in accordance with the present invention;

FIG. 2 is a second upper perspective view of a secured medication reserve vault in accordance with the present invention;

FIG. 3 is an entity-relationship diagram illustrating relationships between components of a system for securely dispensing medication from a medication repository in accordance with the present invention;

FIG. 4 is a block diagram illustrating components of one embodiment of a tamper-proof apparatus for securely dispensing medication in accordance with the present invention;

FIG. 5A is a top perspective view of a carrousel for warehousing medication within a secure vault in accordance with the present invention;

FIG. 5B is a lower perspective view of a carrousel for warehousing medication within a secure vault in accordance with the present invention; and

FIG. 6 is a flowchart of a method for securely dispensing medication from a vault in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

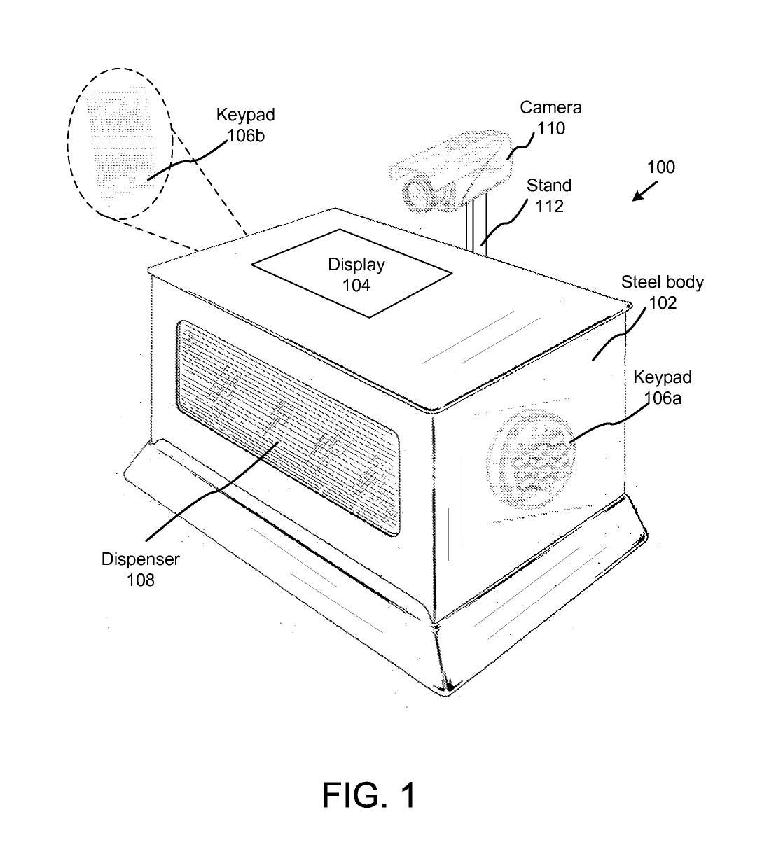

FIG. 1 is an upper perspective view of one embodiment of a secured medication reserve vault 100 in accordance with the present invention. The vault 100 comprises, in the shown embodiment, a steel body 102, a display 104, a keypad 106a, a keypad 106b, a dispenser 108, a camera 110, and a camera stand 112.

The steel body 102 comprises a housing fabricated from steel. The body 102 may also be fabricated, in other embodiments, from one or more of elastomeric materials, aluminum, titanium, wood, fiberglass, and/or other materials known to those of skill in the art. The housing 102 defines a hollow interior recess which houses the internal operational components of the vault 100, including, in some embodiments, a power supply, such as a UPS (uninterruptible power supply).

The vault 100 may comprise a sub-system or one or more data processing devices (DPDs), such as a server, computer workstation, router, mainframe computer, or the like. In various embodiments, the vault 100 comprises one or more processors. The processor is a computing device well-known to those in the art and may include an application-specific integrated circuit (“ASIC”).

In the present invention, the vault 100 is interconnected on a wide area network (WAN) with a server managed by a governmental entity, such as the Food and Drug Administration (FDA), a pharmacy, or the like, using means known to those of skill in the art. The vault sends a virtual event code to this governmental entity, and receives a confirmation code in return which activates the dispenser 108 and dispenses medication to a patient needed medication reposited in the vault 100.

The camera 110 captures video data and routes video, graphic and/or audio data captured by the camera 110 and/or microphones forming the camera 110 to persistent computer readable storage forming the vault 100 and/or to a remote, external server in logical communication with the vault 100 via the Internet. The camera 110 is well-known to those of skill in the art. The camera 110 is mounted on a stand 112, which is also well-known to those of skill in the art.

The display 104 may comprise a graphic user interface (GUI), touchscreen, and the like, as known to those of skill in the art. The display 104 may be configured by the vault 100 to display information to a patient relevant to the patient's medical needs, such as the time that has elapsed since the patient was previously dispensed medication by the vault 100, the amount of medication still warehoused in the vault 100, and the like.

The display may prompt a patient to enter personal information, such as name, address, email, telephone, medical condition, age, gender, payment information, and the like. In some embodiments, the vault 100 may be configured, using APIs, to diagnose medical conditions of the patient. The vault 100 may also be retrofitted with iris scanners x-ray imaging apparati, or other electronic medical devices to assist in verifying a medical condition of the patient.

The keypads 106a-b are well known to those of skill in the art. In the shown embodiment, however, the keypads 106a-b are uniquely oriented. The vault 100 comprises two keypads 106a-b on opposing sides of the housing 102, such that each keypad 106 faced away from the other such that users depressing keys on the keypads 106a-b simultaneously cannot see the keys being depressed on the opposing keypad 106.

In various embodiments of the present invention, the dispenser 108 is activated only upon receiving two output codes in essentially simultaneous fashion, each originating with one of the keypads 106a-b, such that the dispenser 108 only dispenses medication when a patient and an authority like a doctor both input keys into the keypads 106a-b simultaneously.

The dispenser 108 comprises an external door accessible through an aperture, hole or recess defined by the housing 102. In various embodiments, the dispenser 108 pulls a bottle of medication with an arm from a jar housed on a shelf or carrousel internal to the housing 102 while also electronically opening the door forming part of the dispenser 108. In these embodiments, the door and arm may be hydraulically activated.

In the shown embodiment, prescription medication in doses and quantities individualized for the patient by a doctor and/or the governmental entity, are reposited in the vault 100 to be dispensed at predetermined intervals of time when a code or key is keyed into one of the keypads 106a-b while a corresponding code or key is input into by a doctor or other third-party into a second of the keypads 106a-b.

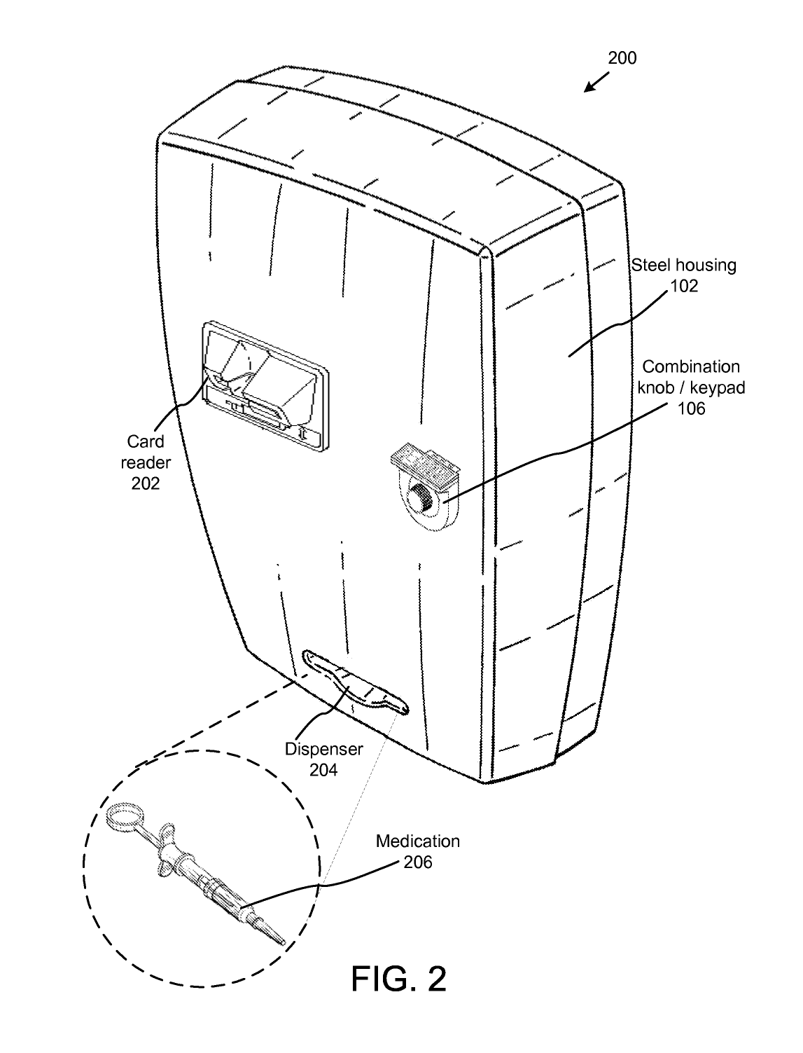

FIG. 2 is a second upper perspective view of a secured medication reserve vault 200 in accordance with the present invention. The vault 200 comprises a steel housing 102, a combination knob/keypad 106, a card reader 202, a dispenser 204, and medication 206.

The steel housing 102, in the shown embodiment, varies in shape but not function from the steel body 102 shown in FIG. 1. The vault 200, however, comprises a card reader 202 in place of one of the keypads 106a-b. In this embodiment, either the doctor or the patient may insert a card with a magnetic strip or RFID tag into the card reader 202. The card reader 202 is known to those of skill in the art, and may be electronically connected with a signal bearing medium either to the dispenser 204, dispenser 108, or a processor internal to the housing 102.

The keypad 106, in the shown embodiment, may accept input of the key either with the electronic pad or a mechanical combination if electrical power to the vault 200 fails. The vault 200 is designed to function on electricity when it is available, or to be opened and dispense medication 206 mechanically in the absence of electricity when a code exclusive to a doctor is entered into the combination/keypad 106.

The keypad 106 may comprise a microcomputer and control memory having recorded therein a PIN number. The keypad 106 may output a signal when a PIN input by a patient matches the PIN in control memory.

The medication 206 in the shown embodiment comprises a hypodermic needle filled with a prescription medication such as insulin, but may comprise in other embodiments morphine, stimulants, narcotics, antidepressants, methadone, immunosuppressants, or other medications known to those of skill in the art. The medication 206 may also comprise medication in jars, bottles, packets and the like.

In various embodiments of the present invention, the device 200 dispenses medication 206 to an individual authorized by a governmental organization, such as the FDA, to then disburse the medication 206 to a patient. In those embodiments, the device 200 may comprise printing means, for printing and affixing labels to medication 206 identifying the patient for whom the medication 206 is intended.

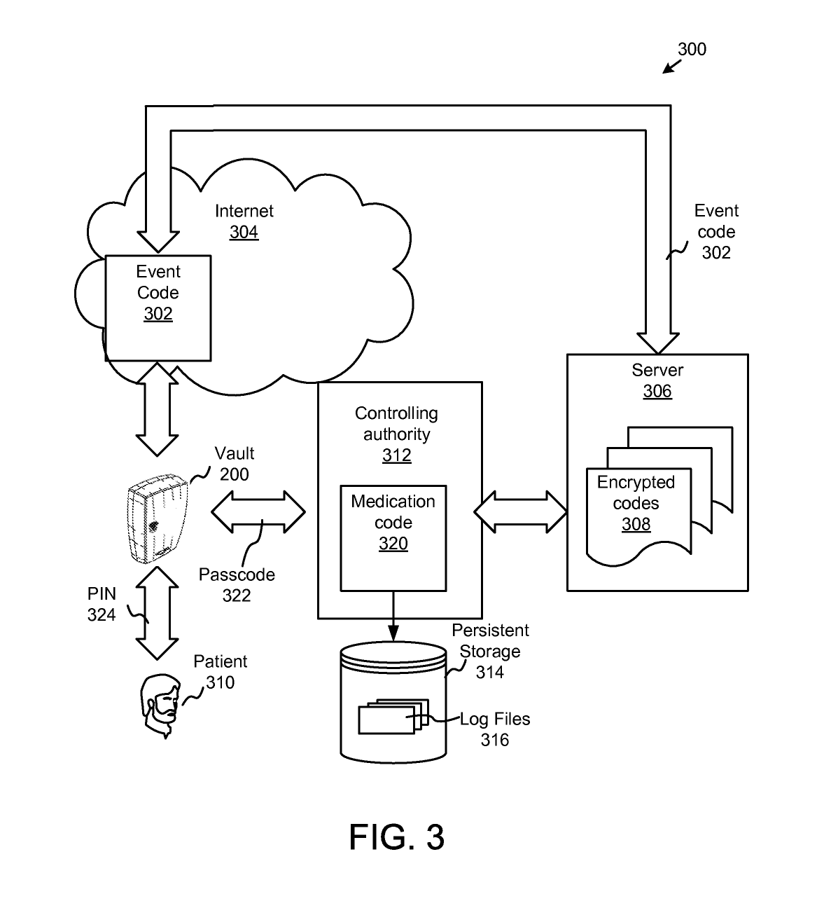

FIG. 3 is an entity-relationship diagram illustrating relationships between components of a system 300 for securely dispensing medication from a medication repository in accordance with the present invention. The system 300 comprises a vault 200, an event code 302, an Internet 304, a server 306, encrypted codes 308, a patient 310, a controlling authority 312, a medication code 320, persistent storage 314, log files 316, a passcode 320, and a pin 324.

As disclosed above, the vault 200 may, in typical embodiments, be in logical communication with the controlling authority 312 through a networked environment, such as local area network (LAN) or wide area network (WAN) or the Internet 304. The vault 200 communicates with the server 306 under control the of the controlling authority using variations of the Simple Mail Transfer Protocol (SMTP), Internet Message Access Protocol (IMAP), Post Office Protocol (POP), File Transfer Protocol (FTP), or other protocols well-known to those of skill in the art (e.g. TCP/IP).

The server 308 may comprise a server, computer workstation, router, mainframe computer, laptop, Palm Pilot®, iPad®, digital cameras, and the like. The vault 200 and the server 308 comprise the software, systems and functionality necessary to facilitate communication of encrypted event codes and keys.

The server 308 and/or the controlling authority 312, in the shown embodiment, comprise a database management system (DBMS) or relational database management system (RDBMS), such as Oracle, SQL, FireBird, IBM DB2 ®, or the like. This DBMS may retrieve encrypted passcodes 308 and the like from a database in computer readable memory 314. The computer readable memory 314 may be internal or external to the server 308. The vault 200 may also comprise computer readable memory for storing logfiles containing patient access information.

In the shown embodiment, an event code 302 originates with the vault 200 after the patient 310 correctly inputs a proper key, code, card, pin 324, or the like, verifying the patient's 310 identity.

In various embodiments, a second key is required from another party (such as a doctor) before the medication 206 can be dispenses to the patient 310. In those embodiments, once both the key from the patient 310 and the second party have been correctly entered within a predetermined time (e.g. a few seconds) of one another, the event code 302 is relayed to the server 306. In some embodiments, the event code 302 comprises the keys entered by the patient 310 and second party, and the server 306 verifies their accuracy using means known to those of skill in the art before relaying the passcode 322 back to the vault 200.

The server 308 is configured to verify that one or more secondary criteria have been satisfied before communicating a passcode 322 to the vault 200 which activates the dispenser 204. The event code 302 may comprise the pin 324 entered by the patient 310.

A computer-readable log 308 of encrypted codes for a plurality of vaults 200 in logical connection with the controlling authority 312 and/or the server 306 is managed by the server 306. In various embodiments, one or more codes exclusively associated with the type of medication 206 and dosage being dispensed are stored in persistent storage 314 in database files 316.

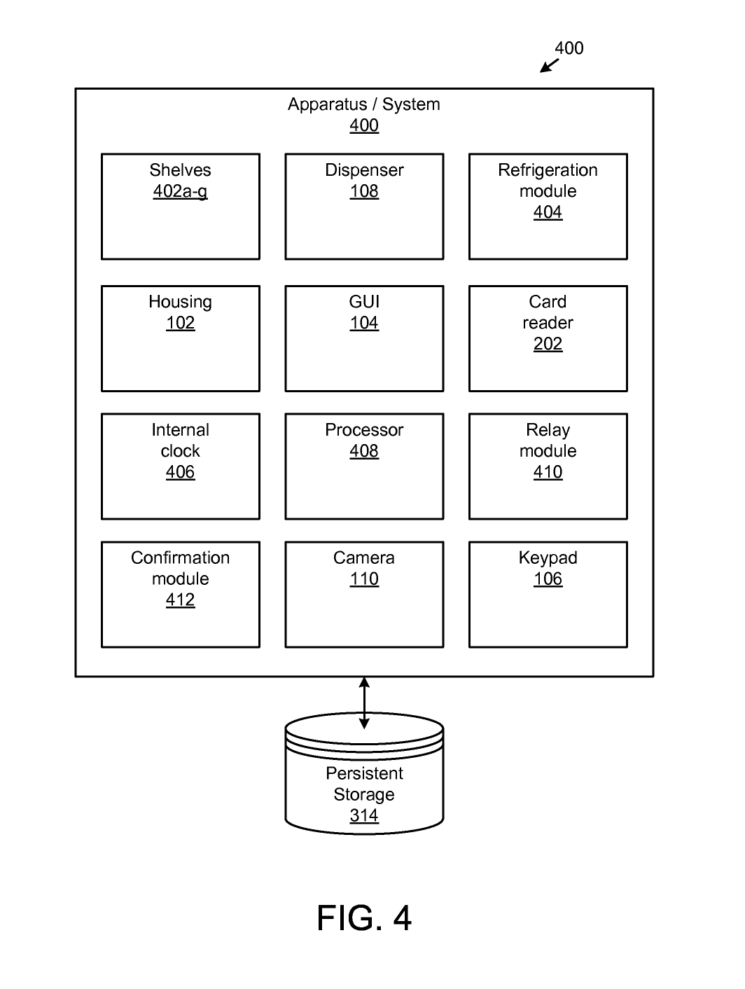

FIG. 4 is a block diagram illustrating components of one embodiment of a tamper-proof apparatus 400 for securely dispensing medication in accordance with the present invention. The apparatus 400 comprises internal shelves 402a-g, a dispenser 108, a refrigeration module 404, a housing 102, a GUI 104, a card reader 202, an internal clock 406, a processor 408, a relay module 410, a confirmation module 412, a camera 414, a keypad 106, and persistent storage 314.

The dispenser 108, housing 102, GUI 104, card reader 202, camera 110 and keypad 106 are substantially described above in relation to FIGS. 1-3.

The memory or persistent storage 314 may comprises any computer readable memory, volatile or non-volatile, internal or external, in logical communication with the processor 408.

The processor 408 is well-known to those of skill in the art. The vault 400 may also comprise a webserver, which is well-known to those of skill in the art.

The apparatus 400 comprises a refrigeration module 404 for keeping medication 206 cool, a module known to those of skill in the art.

The relay module 410 relays events codes 302 to the server 306, and the confirmation module 412 confirms that conforming passcode 322 has been received from the controlling authority 312 and/or server 306. In various embodiments, the confirmation module 412 may also confirm that a predetermined amount of time has lapsed since a patient 310 last was dispensed medication 206. For this reason, the confirmation module 412 is in logical communication with the persistent storage 314, which persistent storage 314 contains log files 316 with information about when a patient 310 was last dispensed medication 206.

The dispenser 108 may incorporate a carrousel, shelving, or operate in accordance with other means known to those of skill in the art.

The internal clock 406 tracks time, including the amount of time that has past since a patient 310 last was dispensed medication 206.

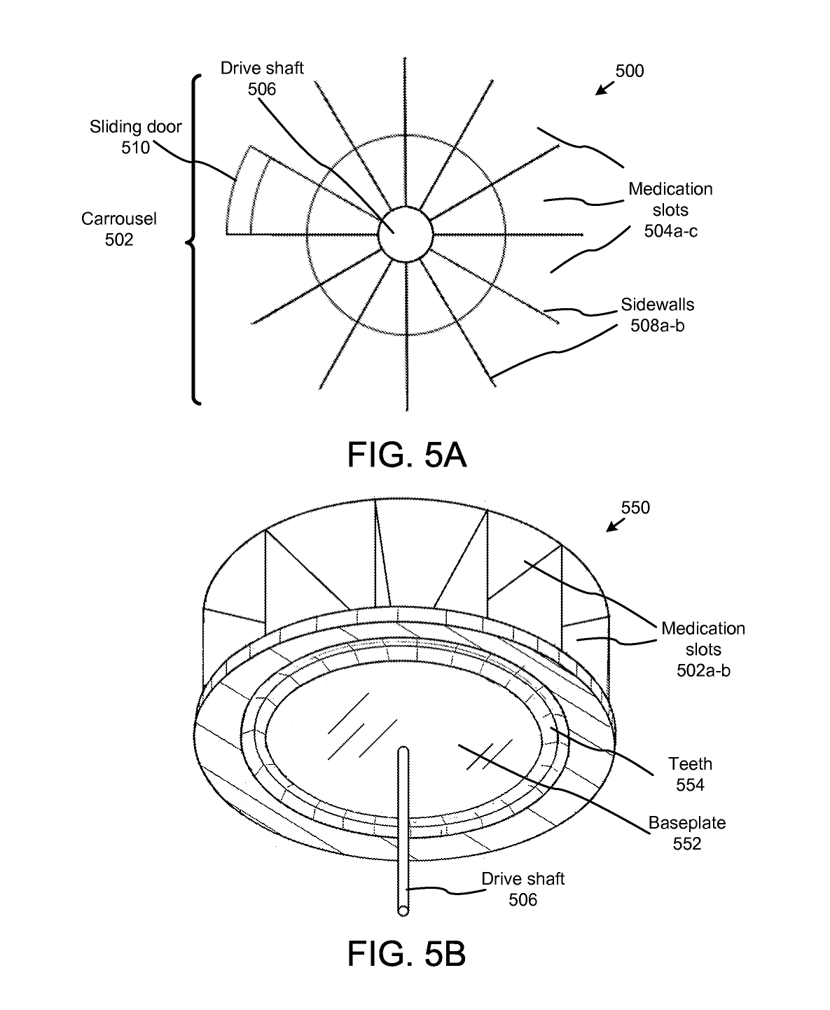

FIG. 5A is a top perspective view of a carrousel 500 for warehousing medication within a secure vault in accordance with the present invention. The shown carrousel 500 comprises a drive shaft 506, twelve medication slots 504, eleven sidewalls 508 separating the medication slots 504 from one another, and a sliding external door 510.

The series of shelves, or slots 504, separated by sidewalls 508, are disposed radially around a drive shaft 506. The slots 504 taper inward toward the drive shaft 506, and are designed to each hold ajar of prescription medication 206 of predetermined quantity and dosage. In some embodiments, the slots 504 of the carrousel 500 comprise one or more doors 510 sealing off the slots 504 from being accessed by the dispenser 108 until the doors 510 are opened.

In various embodiments, these doors 510 are opened by the confirmation module 412 once a predetermined amount of time has passed. In those embodiments, the sliding door 510 may slide from one slot 504a to another slot 504 b as the carrousel turns, thus making medication 206a in one slot 504 accessible by the dispenser 108 while simultaneously sealing off medication 206b in an adjacent slot 504 until a predetermined interval of time has again run its course. The confirmation module 412 may be configured to reset the predetermined periodinterval of time when the sliding external door 510 changes position.

In various embodiments, the sliding external door 510 stays in a static position relative to the housing 102, but changes from slot 504 to slot 504 as the carrousel rotates within the housing 102.

In some embodiments of the present invention, a door on the housing 102 may be opened at any time by a patient 310 with a combination or card, and a single slot 504 on the carrousel 500 in view of the patient 310 via this door. This door may exist in place of the dispenser 108. In those embodiments, the patient 310 may be physically prevented from accessing medication 206 within the slot 504 in view of the patient 310 by one or more sliding doors 310 inside the housing 102 which have not yet opened by the confirmation module 412 using means known to those of skill in the art.

FIG. 5B is a lower perspective view of a carrousel 550 for warehousing medication within a secure vault in accordance with the present invention. The carrousel 550 comprises slots 504 disposed above a baseplate 552, the baseplate 552 having teeth 554 on its lower surface for engaging gears of other modules or components forming the apparatus 100. In some embodiments, the baseplate 552 comprises teeth and the carrousel 550 is rotated around the driveshaft 506 by gears engaging these teeth.

In various embodiments of the present invention, the vault 100 comprises a plurality of carrousels 550 stacked one upon another. Each carrousel 550 may be stocked by a doctor with medication for specific patient 310. The arm of the dispenser 108 may configured with telescopic or a longitudinally extending arm suitable for drawing medication 310 from a carrousel exclusively associated with a specific patient 310.

In various embodiments of the present invention, the vault 100 may comprise a walk-in vault, in which a plurality of vaults 100 are stacked side-by-side and one upon another to form walls defining a room. Each of these vaults may be stocked by a doctor or agent of the controlling authority from an adjacent room via a door on the back of each machine.

In these embodiments, the vaults 100 may share a common front plate, housing 102, server, processor, or other components common to each vault 100 individually.

In other embodiments of the present invention, the vault 100 comprises internal shelves affixed to the inside of the housing 102 in place of the carrousel 550, each shelf in the shelving warehousing ajar of medication for a patient.

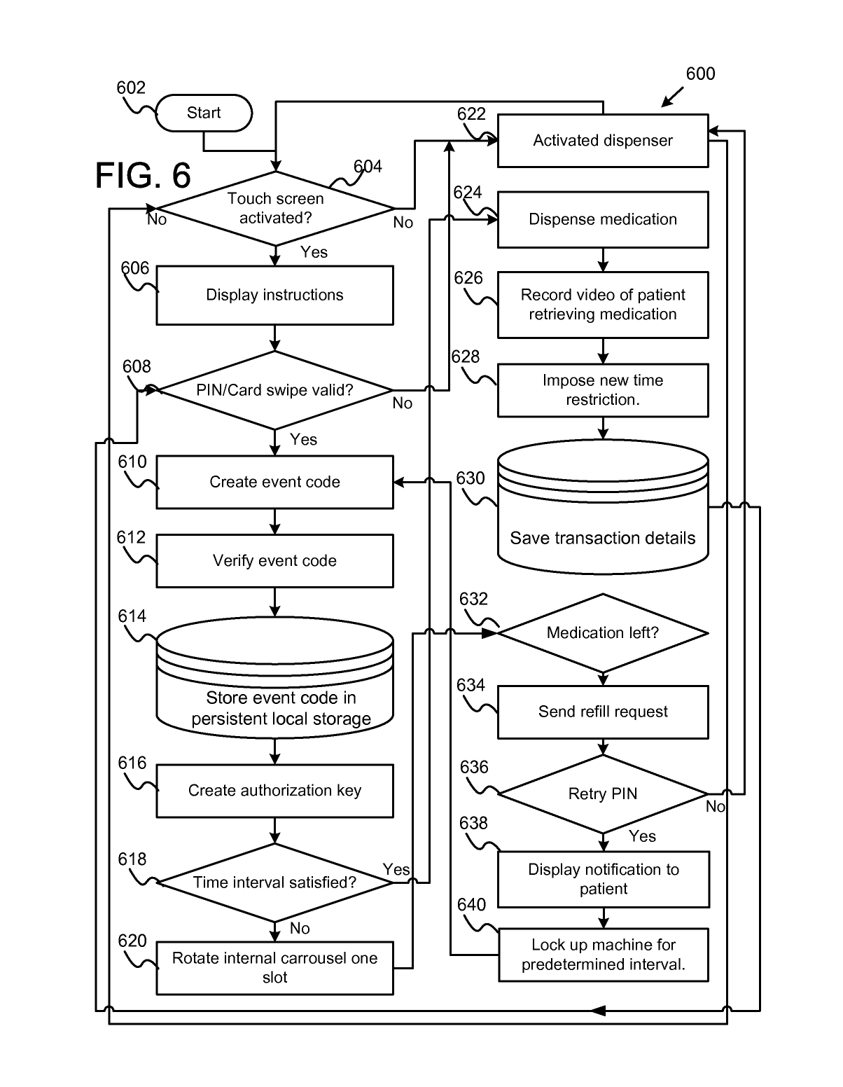

FIG. 6 is a flowchart of a method 600 for securely dispensing medication from a vault in accordance with the present invention. The method 600 begins 602 and proceeds as shown.

The vault 100 may be activated 604 by touching a GUI or touch screen 104 on the vault 100. Instructions are displayed 606 to a patient 310 on the display 104 instructing the patient 310 to insert one or more of a key or card into the vault 100. If, upon the key or card entry is confirmed by the confirmation module 412, the relay module 410 creates an event code 302 which is relays over a WAN to the server 306.

The confirmation module 412, or a human being, verifies 612 that the passcode 322 sent by the controlling authority 312 is valid and saves a record of the verification in persistent memory 314. An authorization key may be created 616 which is sent to the dispenser 108, in response to which dispenser 108 dispenses medication 206.

If the time interval is satisfied 618, the internal carrousel 500 is rotated 620 a distance of one slot 504 clockwise or counterclockwise, and the dispenser 108 is activated 622 in some embodiments. The medication 206 is dispensed 624 and video recording of the patient 310 retrieving the medication 206 is recorded 626 and saved in persistent memory 314.

The internal clock 406 beings counting down through another predetermined interval of time (imposing 628 a new time restriction), and the new time restriction is recorded 630 in computer readable memory 314.

In various embodiments, the patient 310 is given the opportunity to retry 636 PIN, key, or card entry. Notifications may be displayed 638 to the patient 310 on the display 104, and the vault 100 may be locked for a predetermined period of time is a predetermined number of false key or card entries have been attempted by a patient 310 over a period of few seconds or minutes.

The vault 100 may comprise an internal power supply, which may be charged by photovoltaic cells, wind, or by other renewable resources. In various embodiments, only individuals authorized to access the vault may do so, those individuals being person, pharmacists, or technicians licensed or authorized to do by a governmental agency. In various embodiments, these individuals are tasked with dispensing medication after retrieving it from the vault.

The functions of the systems shown in the present invention correspond generally to other systems, methods, apparati and computer program products outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A secured medication warehousing vault for dispensing prescription medication to patients, the vault comprising:
a steel housing securely enclosing operational components of the vault during unattended operation, the housing defining an aperture for dispensing jars of medication;
a graphical user interface (GUI or “display”) for interfacing with a patient disposed on a forward side of the housing;
an internal carrousel comprising a plurality of slots disposed axially on a baseplate around a driveshaft, the slots for storing cylindrical jars of between 0.1 liters and 1 liter in volume;
a card reader affixed to, and in supporting relation with, the housing;
an internal clock configured to relay a first output signal to an electromechanical dispenser after a predetermined period of time has passed in response to receipt of an input signal originating with the processor;
the electromechanical dispenser for dispensing medication from a shelf of the carrousel out of the aperture, the dispenser configured to dispense medication from a slot in response to receiving a second output signal from the processor and a first output signal from the clock;
a processor housed within the housing, the processor in operative connection with persistent computer readable storage, the card reader, the internal carrousel, the dispenser and the GUI, wherein the processor configured to create and output a plurality of output signals;
wherein the processor is responsive to data read by the card reader to create a first output signal causing the internal carrousel to rotate a distance of one slot, and wherein the processor is responsive to data read by the card reader to create a second output signal causing the dispenser to dispense medication from a slot in the internal carrousel to the patient.

2. The apparatus of claim 1, further comprising a steel door having a locking mechanism for replenishing medication in the internal carrousel.

3. The apparatus of claim 1, further comprising a communication module configured to communicate logically with a controlling authority over a WAN.

4. The apparatus of claim 1, further comprising one or more motor affixed to gears, the gears engaging teeth on the bottom of the baseplate for rotating the carrousel around the driveshaft.

5. The apparatus of claim 1, further comprising a camera for recording patient interaction with the apparatus, the camera connected with a signal bearing medium to internal nonvolatile computer readable memory.

6. The apparatus of claim 1, further comprising one or more sliding door(s) of a width equivalent to a width of a slot, the sliding door(s) slidably affixed to the carrousel, the sliding door(s) rotating axially around the carrousel.

7. The apparatus of claim 1, further comprising a plurality of internal carrousels stacked one upon another, each carrousel stocked with medication warehoused within the vault for a specific patient.

8. The apparatus of claim 1, further comprising a plurality of vaults stacked side-by-side and one upon another to form a plurality of adjacent walls, the walls forming a walk-in vault, each vault in the walk-in serialized with a printed label, each vault comprising medication for one or more patients.

9. The apparatus of claim 1, further comprising an internal power supply powered by one or more photovoltaic cells.

10. The apparatus of claim 1, wherein an agent of the US federal government maintains the vault.

11. A system to securely dispense medication to a patient, the system comprising:
a housing defining a hollow recess;
a processor;
computer readable data storage means for storing computer readable data;
a relational database management system (RDBMS);
a GUI;
a card reader;
an accessor module configured to electronically access patient information in persistent memory, said patient information accessible only through a grant of permission of the patient with a PIN number;
a transmitter module configured to transmit an event code to a server under the control of a governmental authority;
a receiver module configured to receive a series of TCP/IP packets from the server and verify an authorization code contained in the TCP/IP packets;
a dispenser module configured to dispense medication from an internal carrousel to the patient in response to a signal from the receiver module sent in response to the verification of the authorization code.
